(19) United States
(12) Patent Application Publication
(10) Pub. No.: US 2012/0214436 A1
(43) Pub. Date: Aug. 23, 2012

(54) Mobile safety devices and methods

(75) Inventors: Richard B. Clark, Los Altos, CA (US); Hoshang Vaid, San Jose, CA (US); Michael York, Fremont, CA (US)

(73) Assignee: Reunite Wireless, Inc., Los Altos, CA (US)

(21) Appl. No.: 13/317,479

(22) Filed: Oct. 18, 2011

Related U.S. Application Data
(60) Provisional application No. 61/455,249, filed on Oct. 18, 2010.

(51) Int. Cl. H04W 4/22

(52) U.S. Cl. 455/404.2

(57) ABSTRACT

A wireless personal communication device provides two-way cellular connection with a subscriber and a contact from a directory stored within the device. A calendar voice reminder may announce to the subscriber time for medications, appointments or other programs. This feature may be programmed and activated via wired or wireless connection with a computer, or by a smart phone, text message or other communication. GPS may provide the location of the subscriber, e.g., via Google Maps or other location mapping service to the selected individuals in the subscribers secured directory. The device provides a simple two-button interface for initiating and receiving communications, including emergency calling and location tracking. A USB connection or interface may charge the battery and/or to provide programming instructions. In other embodiments, the device includes means for communicating via Bluetooth, Wi-Fi or other wired or wireless network connection protocols.

### RELATED APPLICATIONS

This application claims priority under 35 U.S.C. §119 to U.S. Provisional Application No. 61/455,249 filed on Oct. 18, 2011, which application is incorporated by reference herein in its entirety.

### TECHNICAL FIELD

The disclosed embodiments relate generally to wireless communication systems and methods, and in particular to personal mobile safety devices and methods.

### BACKGROUND

Unless otherwise indicated herein, the approaches described in this section are not prior art to the claims in this application and are not admitted to be prior art by inclusion in this section.

In today's environment the aging, the disabled, children and pet population has become increasingly mobile and active. Currently available personal safety communication devices, however, have not kept pace—their limited range, for example, may confine elderly or disabled individuals to their residence, and available devices have no means of wireless tracking or communication when safety and security is jeopardized outside the home. While current smart phone devices have advanced communication features, in many respects such features are far to complicated for many elderly users and children. In these markets there is a need for a simple wireless safety device that enables two-way voice, access to local 911 emergency systems, a calendar activated with a voice announcement (such as medication reminders, appointments and programs) and a stored database of medical history. Accordingly, a small cellular phone and personal safety device has been developed, with features and functionality to minimize cost, optimize ease of use and increase safety benefits to the subscriber and their loved ones.

### SUMMARY

Embodiments of the present invention improve personal safety monitoring. In one embodiment the present invention includes, a mobile safety device comprises a small cellular telephone device including a microcontroller, radio module, antenna, LCD display, battery and memory. The device may include a simple, e.g., two-button, interface for activation, scrolling, and calling. In some embodiments, responder device is water resistant and configured and dimensioned for a small form factor relative to existing mobile telephone devices. The mobile safety device may include attachment means for a lanyard, garment clip, suction cup holder, or other device for securing the responder for convenient access and use.

Systems and methods of the present invention provide a low-cost and easy to use mobile safety device. By integrating certain available and emerging features and functionality of wireless telecommunications networks, e.g., instead of current “land-line” solutions, systems of the present invention provides tracking and voice services with no limitation in range. Optionally, the device may include a communications port, e.g., a USB port or other I/O port, for interfacing with a computer or computer network, e.g., for communications and/or software updates, and/or for supplying power to the device. Other communication features and protocols such as WiMax or Bluetooth may be incorporated.

In some embodiments, a wireless personal communication device provides two-way cellular connection with a subscriber and a contact from a directory stored within the device. The device includes a calendar voice reminder, which will announce to the subscriber time for medication, appointment and programs. This feature may be programmed and activated via wired or wireless connection with a computer, or by a smart phone, text message or other communication. In preferred embodiments, the device utilizes GPS technology to provide the location of the subscriber, e.g., via Google Maps or other location mapping service to the selected individuals in the subscribers directory. The device preferably includes a USB connection or connection or interface to charge the battery and/or to provide programming instructions. In other embodiments, the device includes means for communicating via Bluetooth, Wi-Fi or other wired or wireless network connection protocols.

A device may include a two-button feature set including CALL and HELP buttons, each with a number of functions. A one-push CALL button that will allow the subscriber to scroll downs their directory. Once they have selected their intended caller the subscriber will hold down the call button for two seconds, to complete the connection. A three second—push on the HELP button will allow the subscriber in an emergency situation to dial 911 or equivalent. When this button is pushed a voice announcement will come “You are now dialing 911” a beep signal will follow. If the caller at any point before the beep removes their finger the call will not be made. When the device is active on a call with an incoming call, the CALL button will allow the subscriber to toggle between calls until one of the callers disengages. To turn the device ON and OFF the subscriber will need to push the CALL and HELP button simultaneously for a defined period of time, e.g., three seconds.

In another embodiment, the initialization process is performed via the USB interface, or alternatively via Bluetooth or Wi-Fi connections if available, to program the calling characteristics of the phone. In still other embodiments of the invention, Motion Activated Calling—e.g., using accelerometer technology to determine excessive or sudden motion—may be used to initiate a call, message or other transmission to one or more contacts in the device directory. In another embodiment of this invention, battery recharge is accomplished via an optional charging pad. The Mobile safety device will include on-board memory sufficient to store medical history information about the subscriber that can be downloaded to a computer, or by wireless access. The directory has a security control feature that prohibits predators in calling the device. The subscriber or family member will set up the directory via a PC or smart phone. Incoming and outgoing calls can only be made with those phone numbers that exist in the directory.

In some embodiments, advanced features of a Mobile safety device may include, but are not limited to adjustable volume control and ring tone management that can be controlled through the USB or wireless interfaces to the device, and other similar and common cell phone features. The device may have functionality that can be activated via text from a primary second party smart phone. As a precautionary security measurement, this device will only allow incoming and out going calls with phone numbers that are pre-programmed into the directory. The device may incorporate a silent mode whereby the mobile safety device can be used as an intrusion detection device, allowing a caller to a detect location in a monitoring mode. A lost subscriber feature may allow communication and/or transmission of location information to contacts (e.g., family, friend or neighbor), e.g., if the device or user is lost or abducted. Such a feature may be initiated by a variety of conditions, including without limitation leaving a defined perimeter, or active aggression as detected audibly or by an incorporated accelerometer.

### BRIEF DESCRIPTION OF THE DRAWINGS

For a better understanding of the nature and objects of the invention, reference should be made to the following detailed description taken in conjunction with the accompanying drawings, in which:

FIG. 1 is a schematic diagram of functional components of a mobile safety device according to embodiments of the invention;

FIG. 2 is a front view illustration of a mobile safety device according to one embodiment of the invention;

FIG. 3A is a front perspective view illustration of the device of FIG. 2;

FIG. 3A is a rear perspective view illustration of the device of FIG. 2;

FIG. 4 is an exploded perspective view illustration of the device of FIG. 2;

FIG. 5 is a schematic diagram of a personal safety response system according to embodiments of the present invention;

FIG. 6 is a schematic diagram of a memory and associated modules within a personal safety device according to embodiments of the present invention;

FIG. 7 is a schematic diagram of an administration system for interfacing with a personal safety response system of FIG. 5.

FIG. 8 is a schematic diagram of a personal safety response system and method according to the present invention;

FIG. 9 is a flow chart illustrating an exemplary process a normal state of the method of FIG. 7;

FIG. 10 is a flow chart illustrating an exemplary process of an emergency state of the method of FIG. 8;

FIG. 11 is a flow chart illustrating an exemplary process of an incoming state of the method of FIG. 8;

FIG. 12 is a flow chart illustrating an exemplary process of a call state of the method of FIG. 8;

FIG. 13 is a flow chart illustrating an exemplary process of a message state of the method of FIG. 8;

FIG. 14 is a flow chart illustrating an exemplary process of a sleep state of the method of FIG. 8

FIG. 15 is a flow chart illustrating an exemplary process of an off state of the method of FIG. 8;

FIG. 16 is a flow chart illustrating an exemplary process of a low battery warning state of the method of FIG. 8; and

FIG. 17 a flow chart illustrating an exemplary process of a message reminder state of the method of FIG. 7.

FIG. 18 is a schematic diagram of a database network system according to an embodiment of the present invention.

FIG. 19 is a schematic diagram illustrating communication between a personal safety device and database systems according to the present invention.

FIG. 20 is a schematic illustration of a user interface home screen for a mobile safety device administration system according to one embodiment of the invention.

FIG. 21 is a schematic illustration of a user interface account overview and billing screen for a mobile safety device administration system according to one embodiment of the invention.

FIG. 22 is a schematic illustration of a user interface location screen for determining location of a mobile safety device using an administration system according to one embodiment of the invention.

FIG. 23 is a schematic illustration of a user interface address book or directory configuration screen for a mobile safety device administration system according to one embodiment of the invention.

FIG. 24 is a schematic illustration of a user interface reminder configuration screen for a mobile safety device administration system according to one embodiment of the invention.

Like reference numerals refer to the same or similar components throughout the several views of the drawings.

### DESCRIPTION OF EMBODIMENTS

Described herein are personal safety communication systems and methods. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

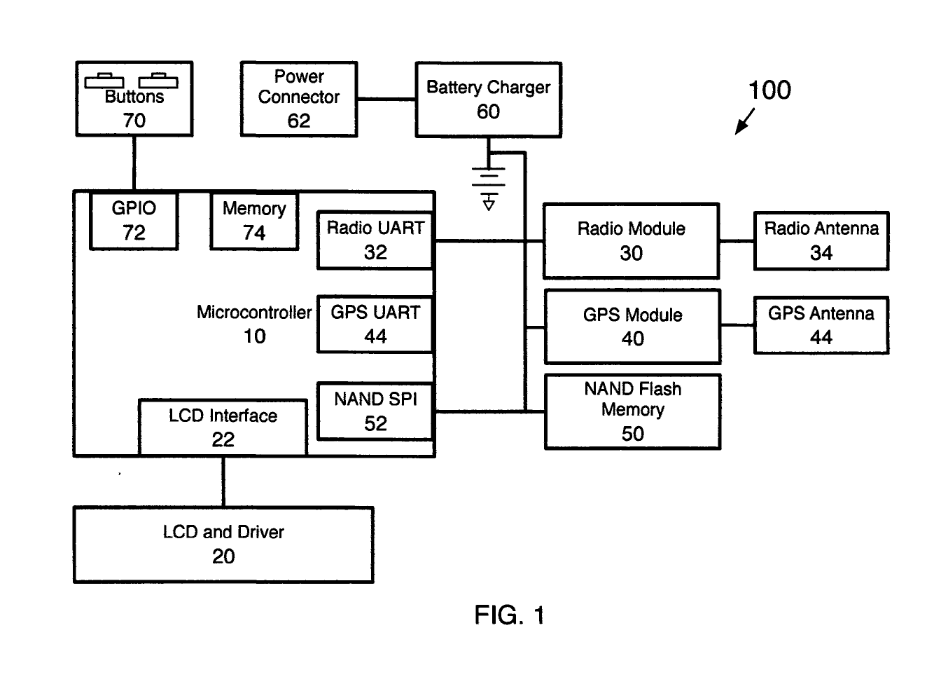

Referring to FIG. 1, a mobile safety device 100 according to some embodiments of the invention includes a microcontroller 10, an LCD interface display 20, a radio module 30, a GPS module 40 and a memory 50. Memory 50 may be flash memory, and may be removable or non removable, such as, for example an SD card, micro SD card, or other removable memory. Microcontroller 10 may include a general purpose input/output (GPIO) module 72 for interfacing with buttons 70, one or more speakers 424 and optionally other input and/or output devices. A memory 74 associated with microcontroller may comprise software modules and instructions for operating device. Device 100 also preferably includes a radio receiver/transmitter (UART) 32 electrically coupled with the radio module 30 for communicating with the radio module 30, a GPS UART 44 electrically coupled with the GPS module 40 for communicating with the GPS module 40, a memory interface 52 for communicating with flash memory 50, and an LCD interface for communicating with LCD and driver 20. A radio antenna 34 may be coupled with radio module 30 to facilitate communications over wireless networks, such as cellular voice, short message service (SMS) messages, and/or data communications. Similarly, a GPS antenna 44 may be coupled with GMS module to facilitate or enable communications with global positioning system (GPS) satellite networks 530, e.g., to retrieve data related to the location of the device 100. In some embodiments, such location data may be sent wirelessly via radio module 30 and antenna 34 over a network to emergency response networks (such as, for example a 911 service) and/or to contacts stored in memory 74 or 50 of device 100. A power connector 62 may be used to provide connection to a power supply, and may provide power to device 100 via a battery and/or battery charger 60.

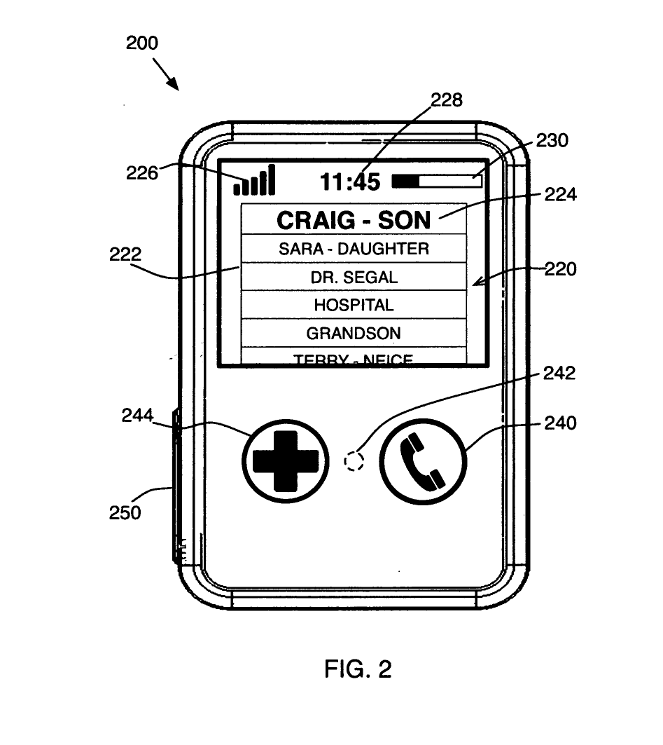

Turning now to FIG. 2, a mobile safety device 200 according to some embodiments of the invention includes a housing 210, display 220, indicators 230, 226, 228 and one or more buttons 240, 244 for receiving user inputs. Disposed within housing 210 is preferably a microcontroller 10 and other associated modules of device 100 as shown in FIG. 1. In some embodiments, display 220 is an LCD screen or other display adapted for displaying information to a user. For example, in some embodiments a menu or directory 222 may include a list of stored contacts displayed to a user and navigable using a single button 240, and a portion 224 of the directory 222 may be highlighted, bold or otherwise distinctively configured to indicate a current state. In some embodiments, a signal strength indicator 226, clock 228 and/or battery indicator 230 may continue to be displayed, while other portions of the display 220, may show different elements, including without limitation, contacts, messages, alarms, reminders, notices and other information depending upon a current state of the device indicators associated with a current state of the device.

In some embodiments, directory 222 may be a secured directory of contact information (e.g., telephone numbers, internet addresses and/or other information) for individuals devices or services to send or receive communications to and from device 200. For example, directory may include telephone numbers for certain family members, an emergency call center, care giver, hospital, or other individuals or services to be contacted by the device (e.g., in the form of a text message, call, GPS location information, or other information) in the event of an emergency or if the user requires assistance. Similarly, incoming communications to the device 200 may be limited to those coming from contacts in the secured directory 222.

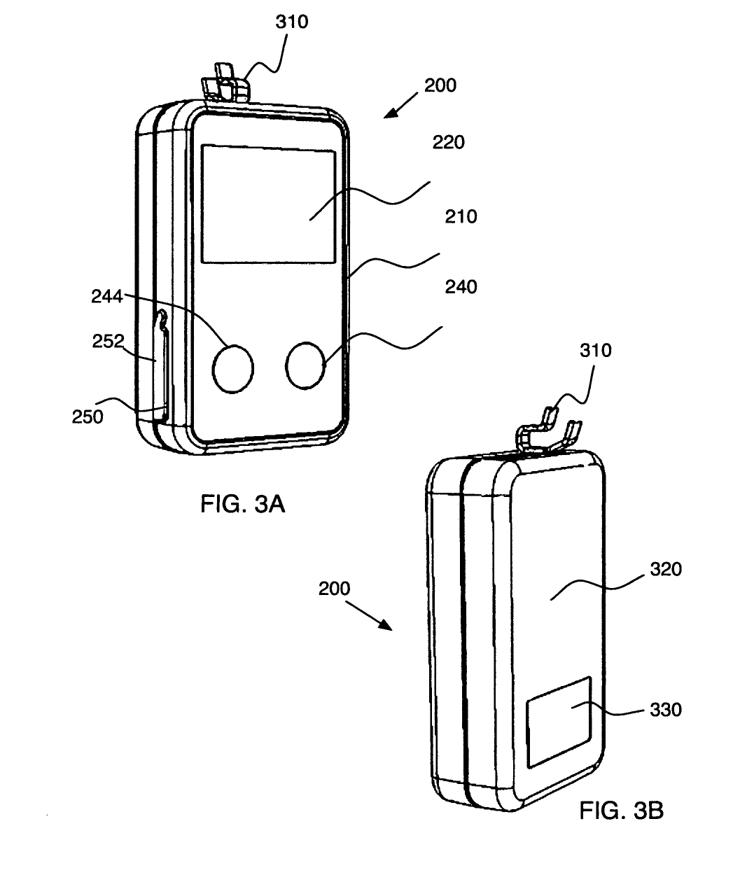

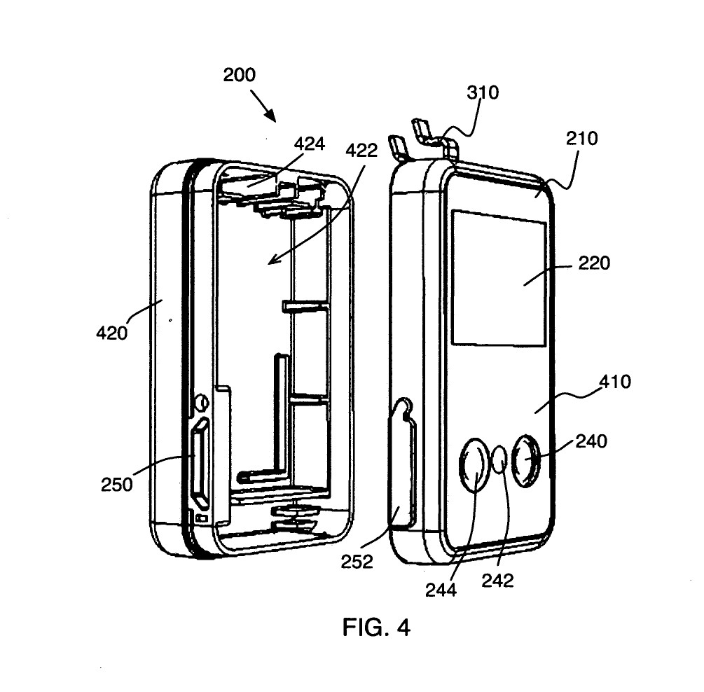

Referring to FIGS. 3A, 3B and 4, device may include a port 250 for connecting to a power source and/or a computer or other external device or network. A cover 252 may be used to protect port 250. A connector 310 may be employed to secure device 200 to a lanyard, strap, case or other attachment means. A back side of device 320 may include one or more additional elements 330, such as, for example, a speaker, an identification label, and/or other devices or indicators.

As shown in FIG. 4, in some embodiments housing 210 of device 200 comprises a front portion 410 and a rear portion 420 adapted to secure together and define an internal compartment 422 for housing device 200 components, such as a microcontroller 10, radio module 30, GPS module 40, memory module 50 and communication antennae 34, 44 from FIG. 1. Also disposed within housing compartment 422 may be one or more speakers 424 and a microphone 242 and any other desired components.

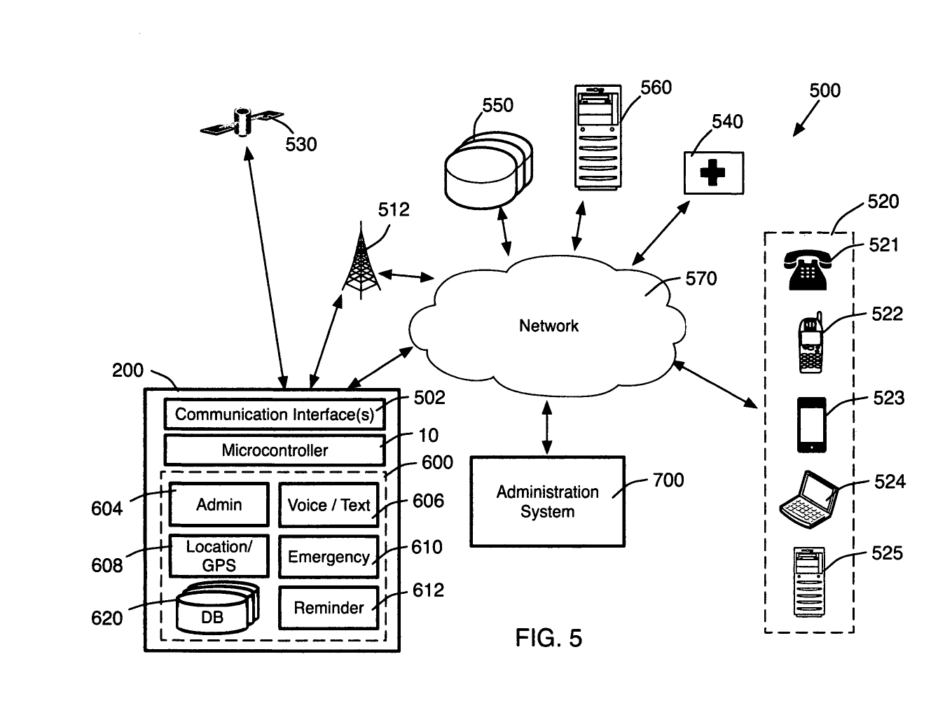

Turning now to FIG. 5, a mobile safety system 500 according to embodiments of the present invention may include a mobile safety device 200 configured to communicate over a network 510 with administration system 700 and any of a group of contacts 520. Such communications may include, for example, voice, text or data communications. System may also communicate with or include a GPS satellite network 530, and one or more wireless communication networks 512. In some embodiments, network 510 comprises networks 512 and 530 and other wired and wireless communication networks for transmitting voice, text, data, video, audio and other information. Contacts 520 may include any of wired telephones 521, mobile telephones 522, smart phones or tablet devices 523, personal computers 524, or servers 520. System 500 may also comprise an emergency call center 540 for responding to emergency calls and/or messages from device 200, and any number of databases 550 and server systems 560 for providing information and data (e.g., map or location data) to device 200 and/or any of contact devices 520 or call center 540.

In some embodiments, device 200 may include one or more communications interfaces 502 for communicating with networks 510, 512 and 530, e.g., a user interface (which may include an LCD 20 and interface 22 and user input devices 70), a radio module 30 and a module 40 as in device 100 of FIG. 1. In some embodiments, communication interfaces 502 include Wi-Fi, Bluetooth, LAN or other wired or wireless communication interfaces. A microcontroller 10 may provide overall operational control and include functional components as shown in FIG. 1, including a memory 74 and interfaces 32, 44, 52, 72. In some embodiments, a memory 600 of device includes software modules such as a device setup and administration module 604, voice and text processing module 606, location/GPS data processing module 608, emergency procedures module 610, and a reminder module 612. Memory 600 may also include one or more databases 620 for storing information, for example user information, calendar data, and contact directories. Memory 600 may comprise ROM, RAM, flash memory, removable or external memory, SIM memory, or any other memory suitable for storing and retrieving information.

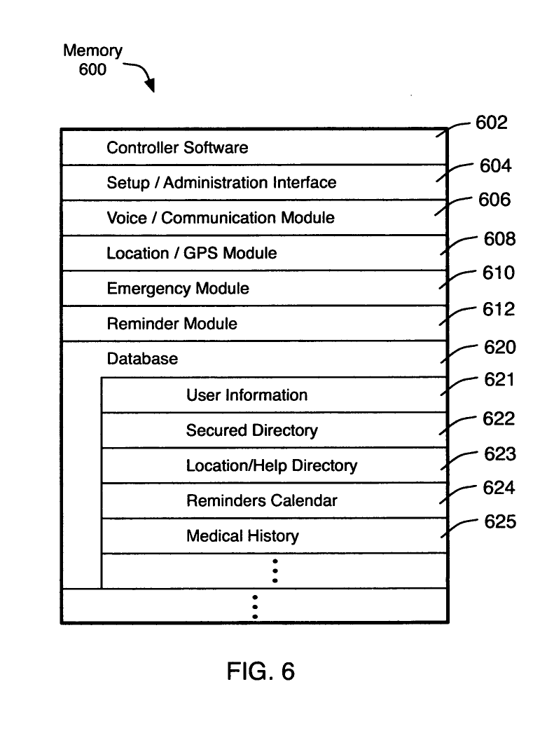

Turning now to FIG. 6, an exemplary memory 600 according to one embodiment of the invention comprises controller software 602 or operating system providing instructions for overall operation of the device and its various components. Administration/Setup module 604 may be used to interface with a remote administration system 700 to setup device 200, including providing information in database 620, configuring subscription information, provide updates, and the like. Voice/Communication Module 606 comprises instructions for sending and receiving calls and processing mobile originated (MO) or mobile terminated (MT) text messages with contacts 520 over network 510. Location/GPS module 608 comprises instructions for communicating with GPS network 530, location and map databases 550 and systems 560, emergency call center 540, and/or specified contacts 521, 522, 523, 524, 525. A reminder module 612 comprises instructions for processing and communicating calendar reminders, medication alerts, alarms, and other desired information to a user of device 200 and/or any of contacts 520. Such reminder communications may be initiated locally within device 200 or over network 510, e.g., by administration system 700 or a contact from group 520.

Database 620 may include instructions, data, and other information used by other modules within device 600. For example user information 621 may include a user's name, address, phone number, passwords, account or subscription information, etc. In some embodiments, a secured directory 622 may include contact information (e.g., name, phone number and/or network address) for receiving and sending communications from the device 200. For example, in some embodiments, the secured directory includes contact information certain family members, friends, care givers, doctors, hospital, and/or emergency services. Depending upon the administration settings and the situation, incoming and/or outgoing calls and messages can be restricted to contacts in the secured directory or a subset of such contacts. In some embodiments, the directory has a security control feature that prohibits predators in calling the device. The user/subscriber or a family member may set up the directory via a PC or smart phone communicating with device 200 locally or over a network 510. In some embodiments, Incoming and outgoing calls can only be made with those phone numbers that exist in the directory.

In some embodiments Mobile safety device 100, 200 includes on-board memory 600 sufficient to store medical history 625 information about the subscriber that can be uploaded to a computer, or transmitted wirelessly to family members, health care information systems or other care providers requiring such information to assist the user. Medical history information may also include medication history and schedules, e.g., to provide medication reminder alerts to the user. In some embodiments, a medication reminder alert will require an acknowledgement, e.g., push and hold a button 240, 244 for a defined period of time to acknowledge receipt of message and/or compliance with a treatment protocol, and such acknowledgement may be sent to a contact 520 and/or administration system 700.

Administration system 700 communicates with device 200, e.g., via a network 100 or other direct communication means (e.g., a USB connection, Wi-Fi, LAN, Bluetooth, or other wired or wireless communication protocol). Administration system 700 may be used to store and provide communication instructions, manage communications, back up user account settings, and optionally provide communication logs. In some embodiments, system 700 may include data and instructions pertaining to multiple devices 200 and corresponding users/subscribers.

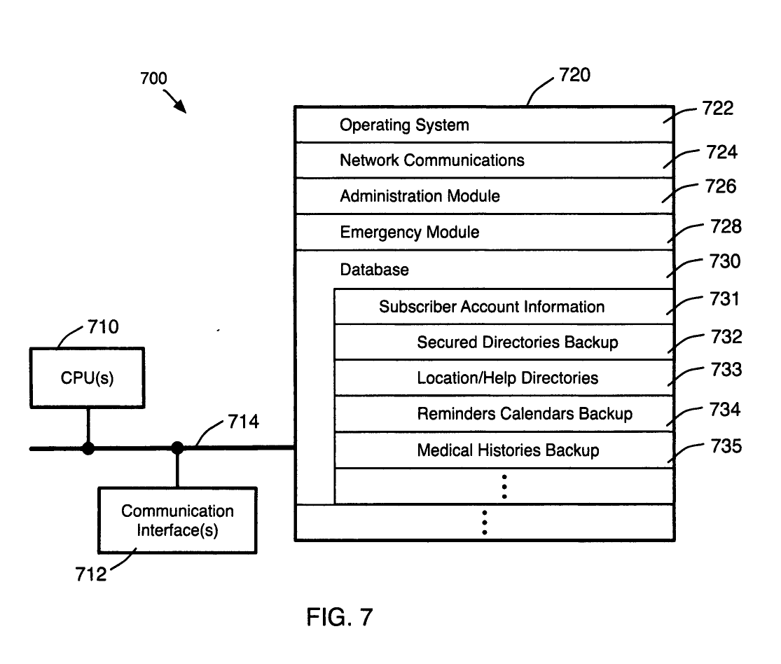

FIG. 7 is a block diagram of an administration system 700 (from FIG. 5). System 700 may include at least one data processor or central processing unit (CPU) 701, and at least one communication or network interface 714 for communicating with other computers, servers (e.g., server 570 or a server within system 700), databases 550 (which may be included within or separate from administration system 700), devices 200, contact devices 520, and emergency services 540. System may also include a memory 720 and one or more signal lines or busses 714 for coupling system components to one another. The one or more signal lines or busses 714 may include one or more communication busses.

Memory 720 may include high-speed random access memory (RAM) and/or non-volatile memory, such as one or more magnetic disc storage devices. Memory 720 may store an operating system (or set of instructions) 722, such as LINUX, UNIX, MAC OS, or WINDOWS, that includes procedures for handling basic system services and for performing hardware independent tasks. Memory 720 may also store communication procedures (or a set of instructions) in a network communications module 724. The communication procedures are used for communicating with other devices, such as device 200, server 560, databases 550, emergency system 540, or devices 520, 521, 522, 523, 524, 525, or with other computer systems within system 700.

Administration module 726 of FIG. 7 comprises procedures or instructions for configuring and managing devices 200 and corresponding user accounts. An emergency module 728 includes procedures and instructions for sending and receiving voice, text, and data between device 200 and other elements of network 500 (e.g., contacts 520, emergency call center 500, a location services system 560) in response to an emergency signal initiated by the device 200 or its user (e.g., by pushing and holding an emergency call button 244 for a defined period of time, or in response to an accelerometer, voice response system or other automated apparatus or system associated with the device 200 and configured to initiate an emergency process in response to a signal from such automated apparatus or system.

A database 730 of system 700 may include subscriber account information for a plurality of subscribers to a mobile safety service utilizing system 500. Such information may include, for example, backups of secured directories for one or more mobile safety devices 100, 200, location/help directories for each subscriber, copies of reminder calendars for transmission to devices 200, and backup copies of medical history information or other data for operating or configuring one or more devices 200.

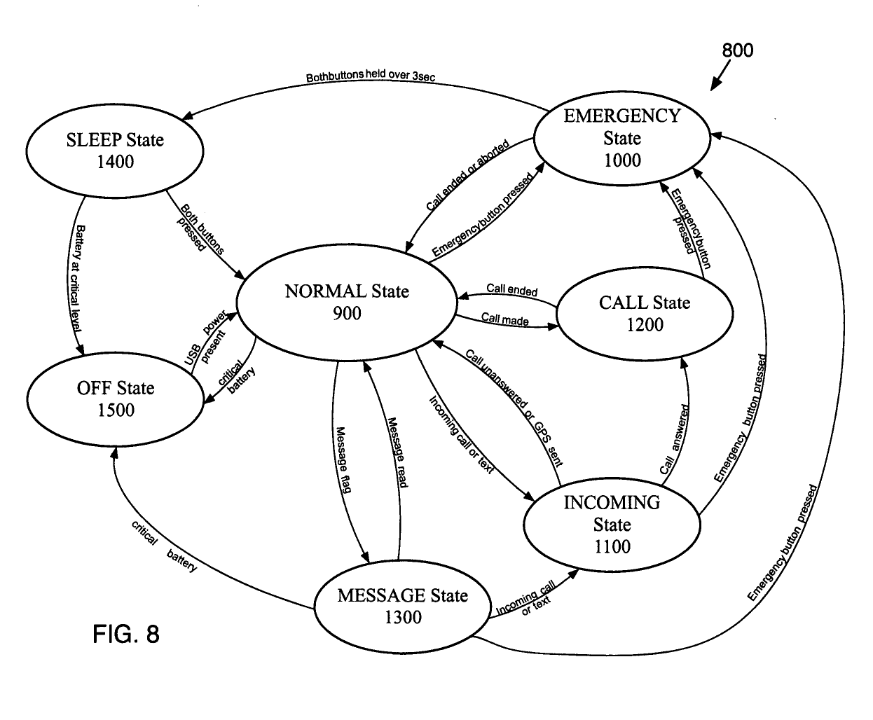

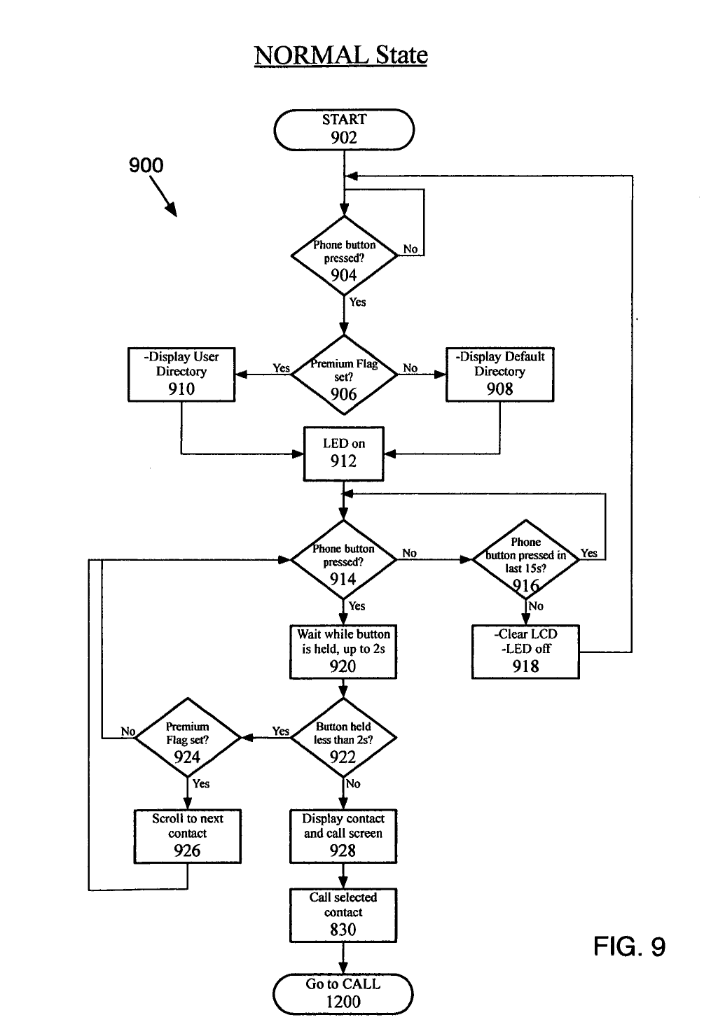

FIG. 8 is a schematic diagram of a mobile safety response system and method 800 according to one embodiment of the present invention, showing interactions between different states of a mobile safety device such as device 100 or 200. Different states of the device include a normal or standby state 900 from which other states or processes may be performed, an emergency state 100 for initiating emergency calls, transmission of location information and/or or messages, an incoming state 1100 for receiving incoming calls and text messages, for example, a call state 1200 for making voice calls, a message state 1300 for sending and receiving messages and reminders, a sleep state 1400 for conserving battery life and system resources during non-use, and an OFF state 1500 with instructions for turning the device 200 on and off. Details of exemplary methods and processes for each of the foregoing states 900, 1000, 1100, 1200, 1300, 1400, and 1500 are state are set forth below with references to FIGS. 9-15, respectively.

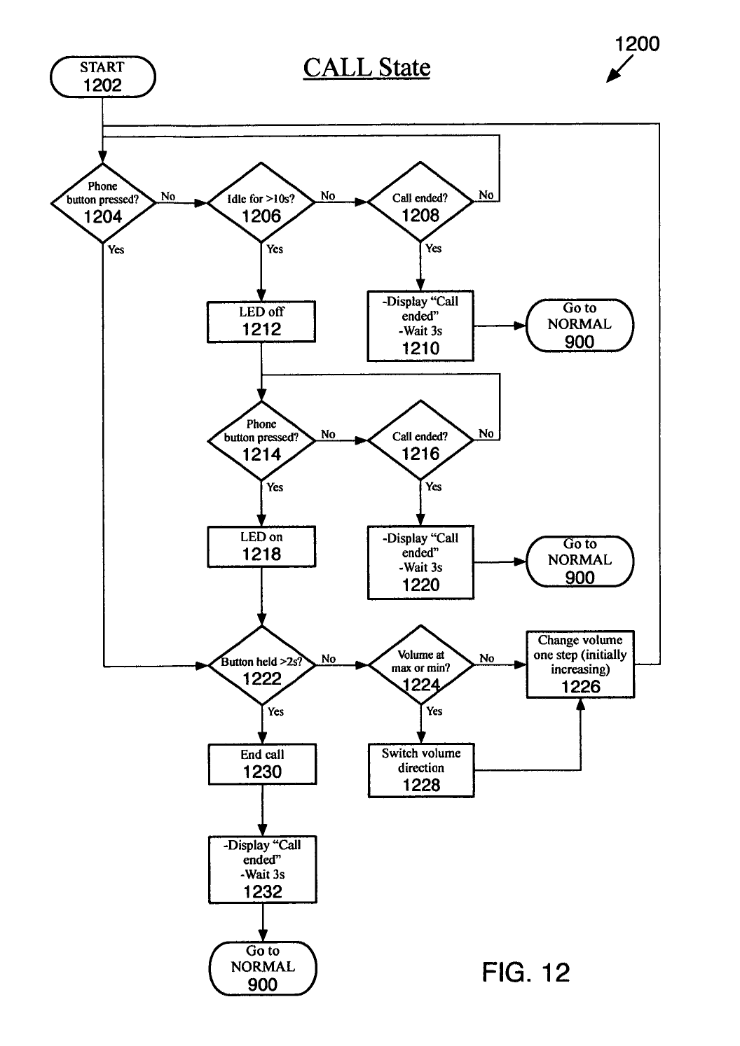

Referring to FIG. 9, a normal state method 900 according to one embodiment, starts 902 and waits for a phone button to be pressed 904. If phone button is pressed, the system 200 checks it account settings to see if a premium flag has been set 906, e.g., indicating a premium subscription and availability of certain services, such as, for example, a custom user directory which is displayed in 910. If no premium service is available, a default directory is displayed 908 and LED display (220 of FIG. 2) is turned on 912. If phone button (240 of FIG. 2) is pressed for less than 2 seconds in 920 and 922, or for another defined period of time, and the premium flag is set 924, then the next contact is scrolled 926. In this manner, a user having a premium subscription may scroll through contacts in its device 200 directory. If the button is held longer than 2 seconds, for example, the current contact and call screen is displayed 928 and a call to the selected contact is initiated 830, commencing the call process 1200 of FIG. 12. From the normal state, each other state emergency 1000, incoming 1100, call 1200, message 1300, sleep 1400 and off 1500 may be initiated, and each such other state may terminate with a return to the normal state 900.

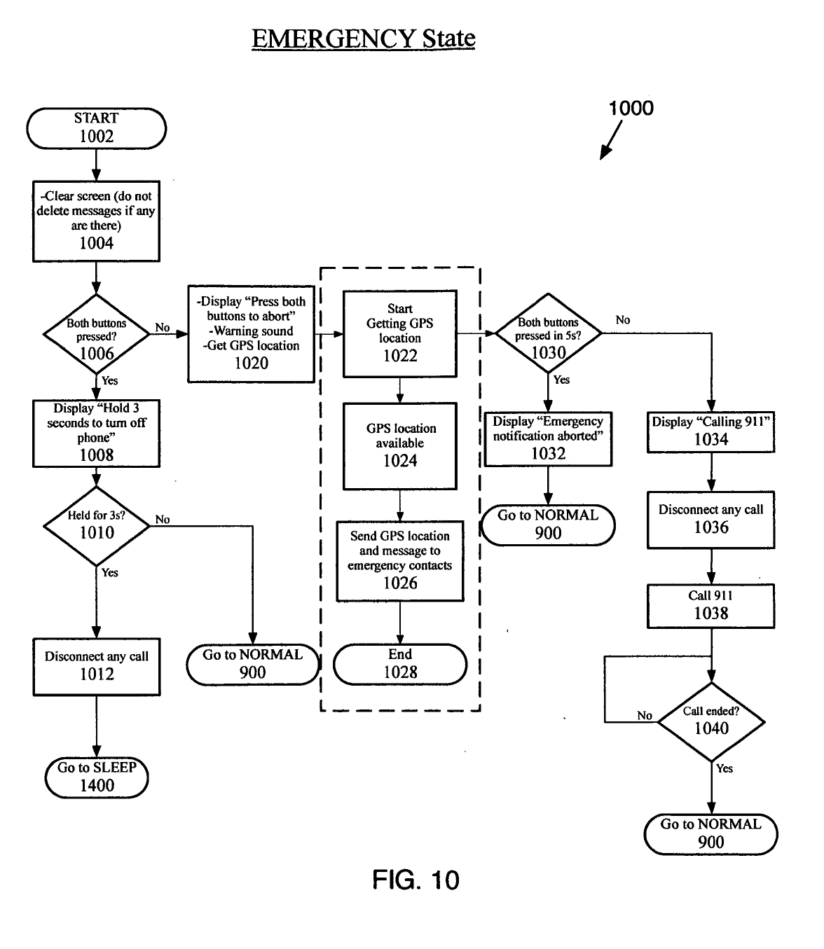

FIG. 10 is a flow chart illustrating an exemplary process of an emergency state 1000 of the method of FIG. 8. If an emergency state is initiated 1002, e.g., by pressing emergency button 244, and if both buttons (or some other defined combination of buttons) is not pressed 1006, then a warning may be displayed or a warning sound may be emitted 1020 by device 200 to signal to a user that it is in emergency mode 1000. In this example, GPS location is then retrieved (e.g., from GPS network 530 and possibly utilizing other 3^{rd} party location services or map servers 560) 1022, 1024 and the device 200 location is sent to emergency contacts in the secured directory of the device, along with a message or call indicating the emergency. Different devices in contact group 520 may receive different messages, depending upon configuration settings and device capabilities. If both buttons are pressed for a defined period of time, e.g., five seconds, 1030 then the emergency mode may be aborted. If not aborted, a call or message to an emergency call center (540 from FIG. 5) may be initiated and completed in steps 1034-1038.

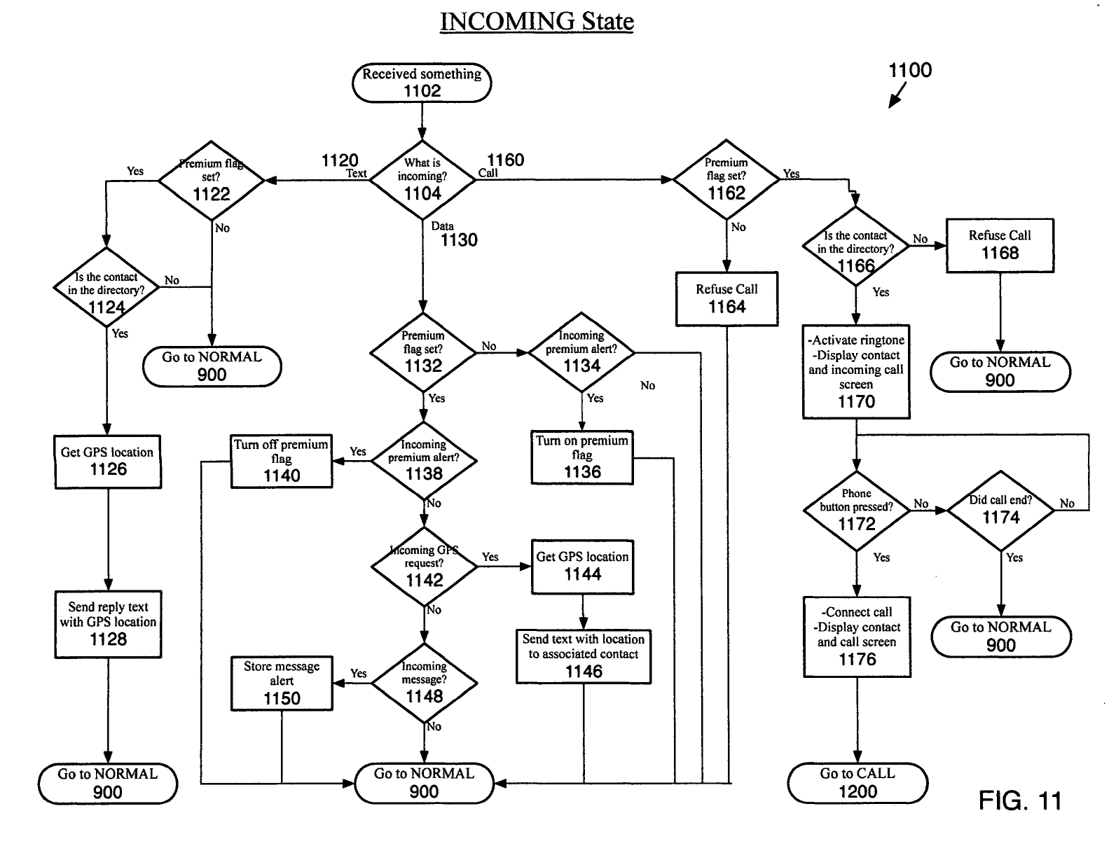

FIG. 11 is a flow chart illustrating exemplary processes of an incoming state of the method of FIG. 8, including receiving text messages 1120, telephone calls 1160, and incoming data 1130. In a text process 1120 according to one embodiment, if a premium flag is set 1122 (e.g., the user is a subscriber to premium service of the system of FIG. 5) and the sender of the message is a contact in a directory of the device in step 1124, GPS location of the device 200 is retrieved in step 1126 and a reply text message is sent to the sender with GPS location information. In some embodiments, an incoming text message 1120 or other data 1130 may be a particular keyword, pass phrase, sound, video, data, etc. that initiates an automated response, such, for example, as sending GPS information, setting off an audible or visual alarm, resetting a system routine, activating audio speaker and/or microphone, retrieving data from the device 200, or activating another feature of the device or system.

In some embodiments, an incoming call 1160 is refused 1164 if a premium subscriber flag is not set 1162, 1164, or if the caller is not in the device's contact directory 1166, 1168. If predetermined conditions are met, where such conditions may be configured on the device or by the administration system, then a call may be received 1170, 1172, 1174

FIG. 12 is a flow chart illustrating an exemplary process of a call state of the method of FIG. 8. At start 1202 a call has already been initiated and is active. Steps 1204 through 1232 illustrate steps in the method of continuing the call and ending the call using a single button or combination of buttons.

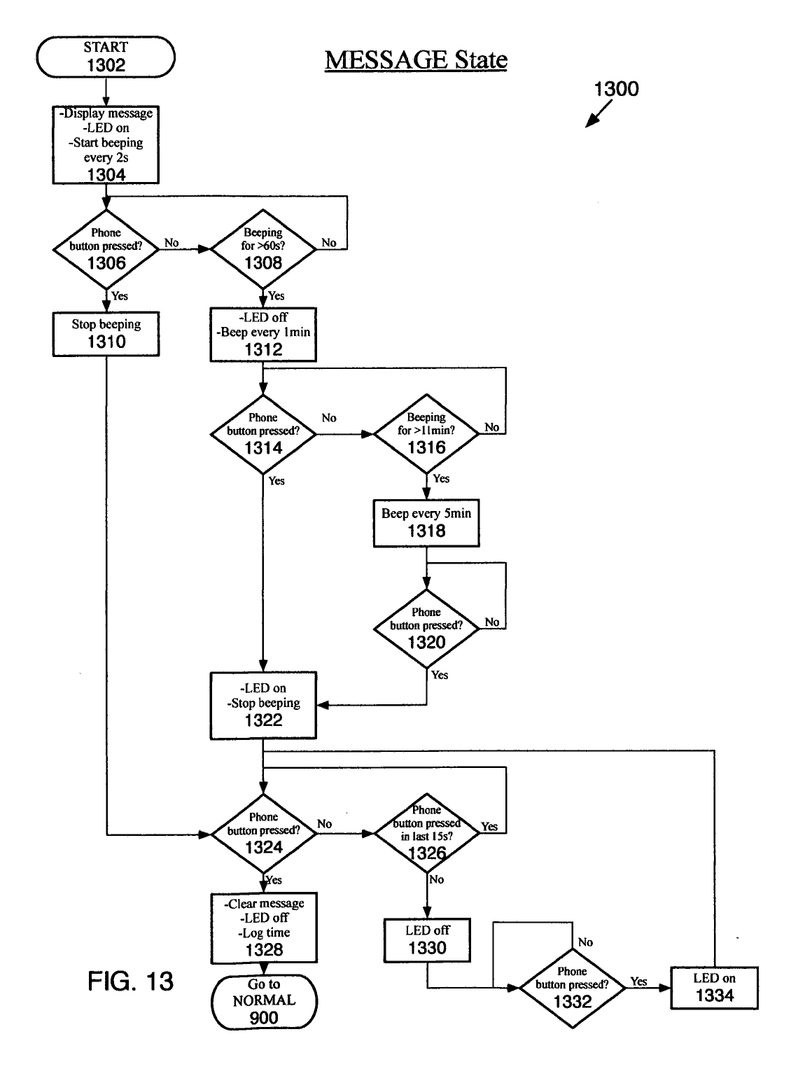

FIG. 13 is a flow chart illustrating and describing an exemplary process of a message state 1300 of the method of FIG. 8. At start 1302, a message or alert has been received, as shown in FIG. 8, initiated by message flag from normal state 900. When a message flag is received, the message is displayed and/or audible signals are emitted in 1304. Depending upon the state of the phone (e.g., display off, beeping alarm, etc.) the phone button (240 in FIG. 2) may be used to stop the signal e.g., in 1306, 1314, 1320, 1324, to clear the message 1324, or to retrieve turn the display on 1334 to show the message. Other steps in the process of 1304 through 1334 are shown and described in FIG. 13.

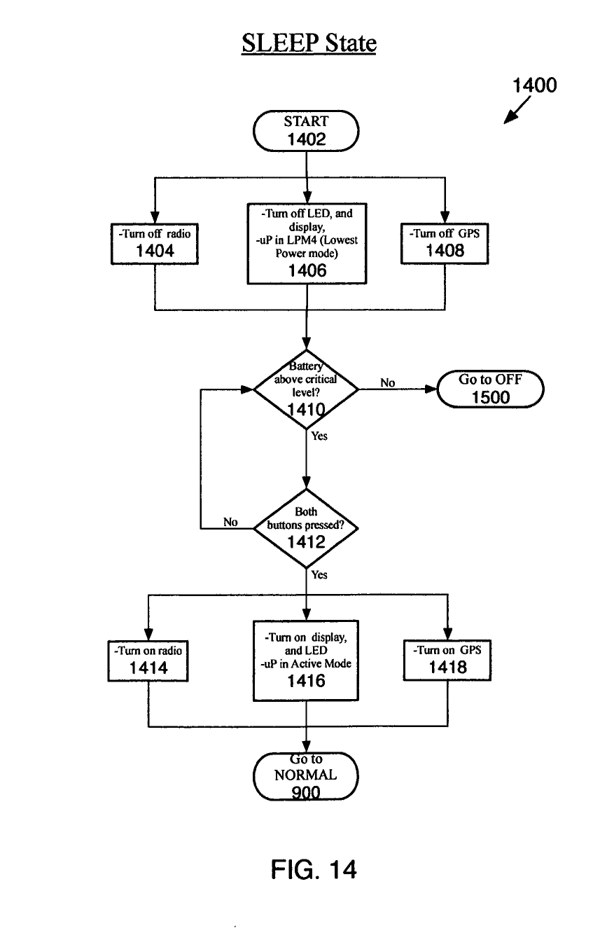

FIG. 14 is a flow chart illustrating and describing steps 1402 through 1418 of an exemplary process of a sleep state 1400 of the method of FIG. 8. During the sleep state 1400, the LED display 220 is turned off and the microcontroller 10 is put in a low power mode 1406. Radio 1404 and GPS 1408 are also turned off. To exit from sleep, if the battery is above a critical level 1410, both buttons (e.g., 240, 244 in FIG. 2) may be pressed 1412 to turn on the LED display and activate the microcontroller 1416, turn on the radio 1414 and turn on the GPS 1418. If the battery is below a critical level, the device 200 goes to the off state 1500.

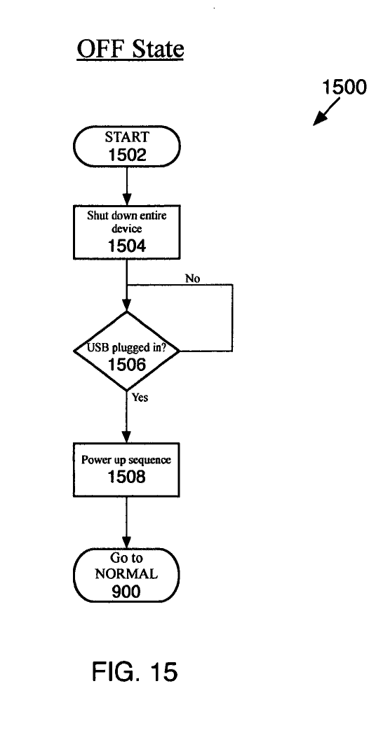

FIG. 15 is a flow chart illustrating an exemplary process of an off state 1500 of the method of FIG. 8. Once the state is entered 1502, the entire device is shut down 1504 until a USB cable or other power source is plugged in 1506 and the device is powered up 1508.

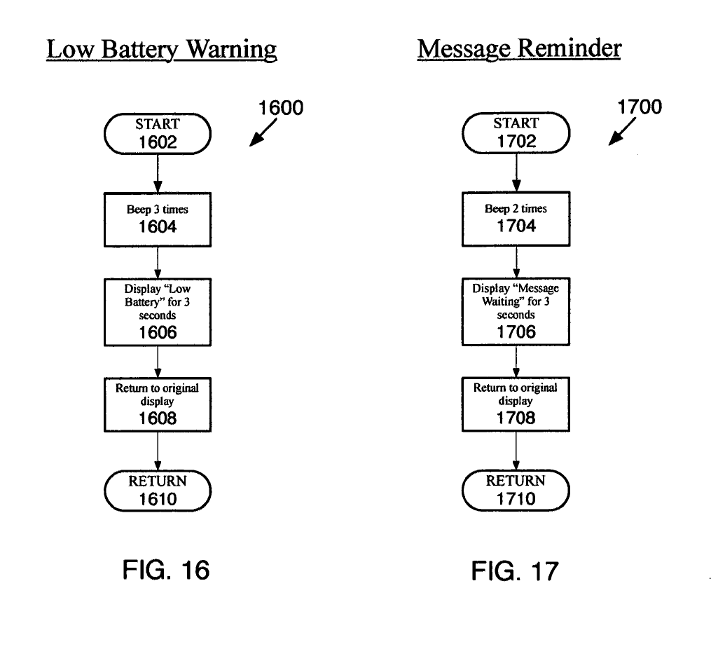

FIG. 16 is a flow chart illustrating an exemplary process, including steps 1604 through 1610, of a low battery warning state 1600 of the method of FIG. 8. FIG. 17 illustrates a message reminder process 1700 comprising steps 1702-1710. Both processed 1600, 1700 involve providing an audible alarm 1604, 1704 followed by a displayed message 1606, 1706 before returning to the original display 1708.

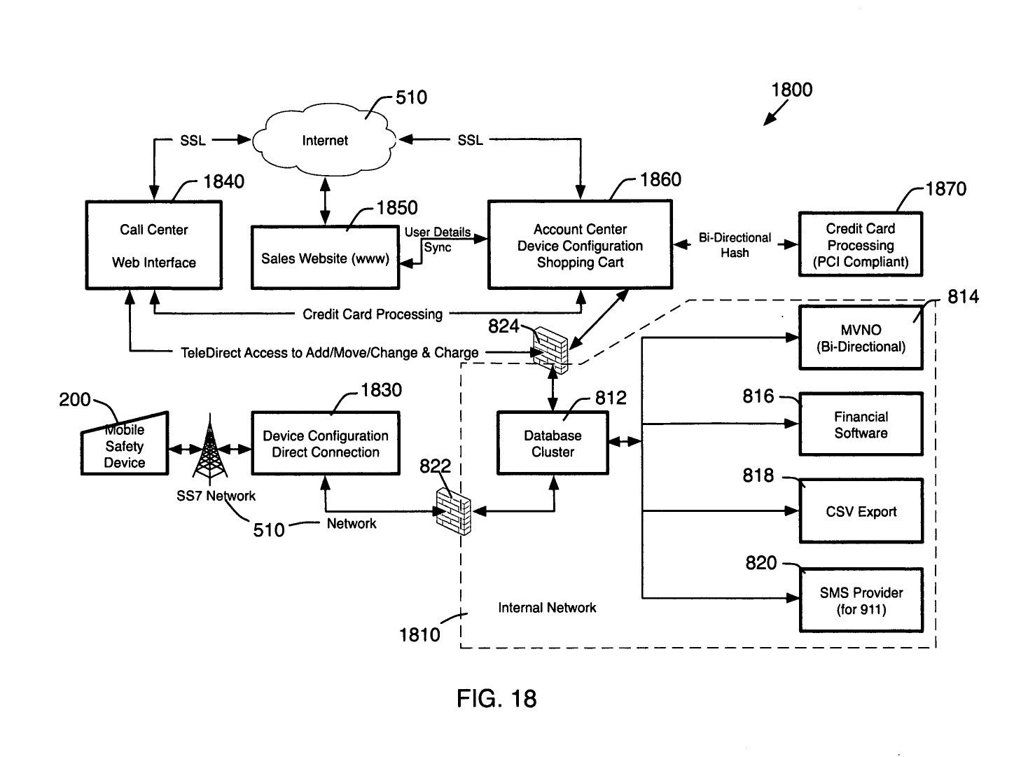

Turning now to FIG. 18, a mobile safety device administration system 1800 is illustrated according to another embodiment of the invention. System communicates with a device 200 and among system components through one or more wired or wireless networks 510, and comprises an internal network 1810 of processing systems and service providers, including database cluster 1812 communicating with a mobile virtual network operator (MVNO) 814, financial software 816, a data converter and export module 818, and a text messaging aggregator or other messaging service provider 820. Internal network 1810 is separated from other elements of the system 1800 by firewalls 822, 824. A device configuration module 1830 may be used to setup and configure device preferences and parameters. Other components of administration system for interfacing with subscribers and potential customers include a call center 184, a sales website 1850 and an account center 1860 for device configuration and purchases. One or more of modules 1840, 1850, and 1860 may be discrete systems communicating with each other over a network 510, or come components may be integrated within subsystems with direct wired or wireless connections. Account center 1860 also communicates with a credit card processing system for processing orders.

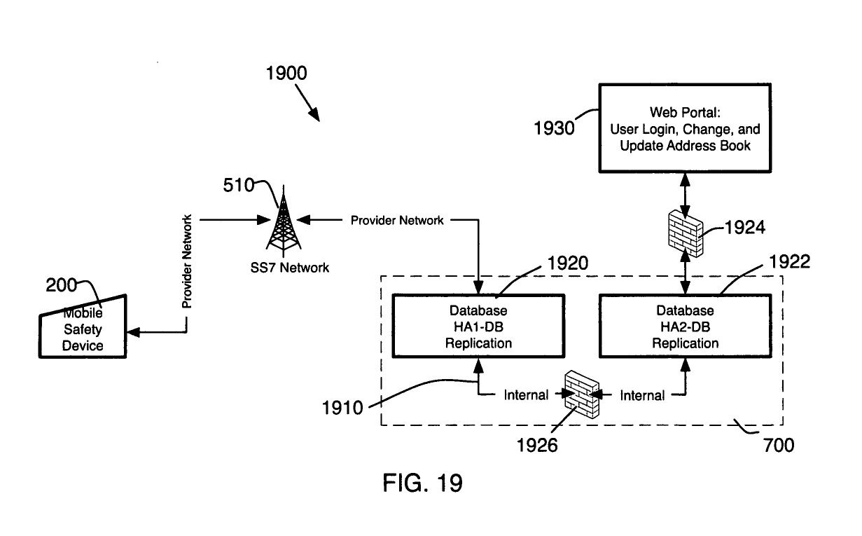

FIG. 19 is a schematic diagram illustrating communication between certain components of an administration system 1900 according to some embodiments of the invention. System 1900 may comprise an internal network 1910 including replicated databases 1920, 1922, which may be separated by a firewall 1926. Databases of system 1900 may be the same or similar to databases as described for administration system 700 of FIGS. 5 and 7, including subscriber data and device configuration data. Databases 1920 are connected to network 510, e.g., for communicating with device 200, and may be connected with a web portal 1930, e.g., via a firewall 1924, for providing device configuration and administration tools.

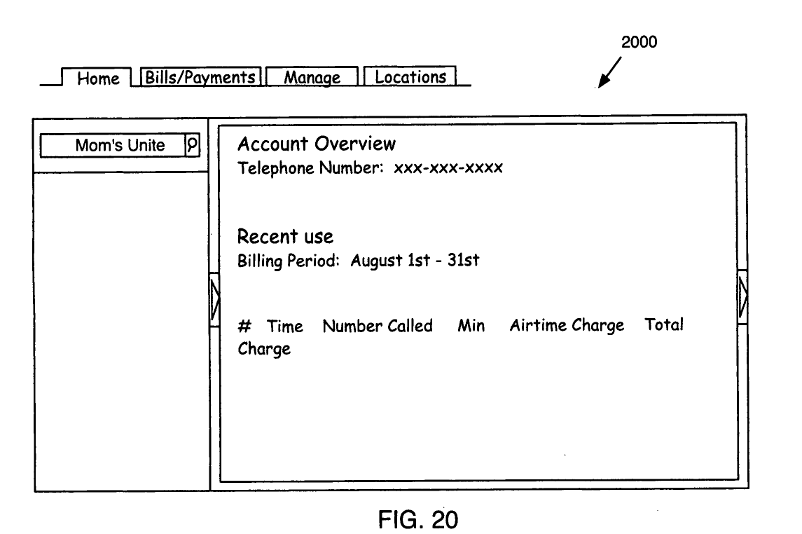

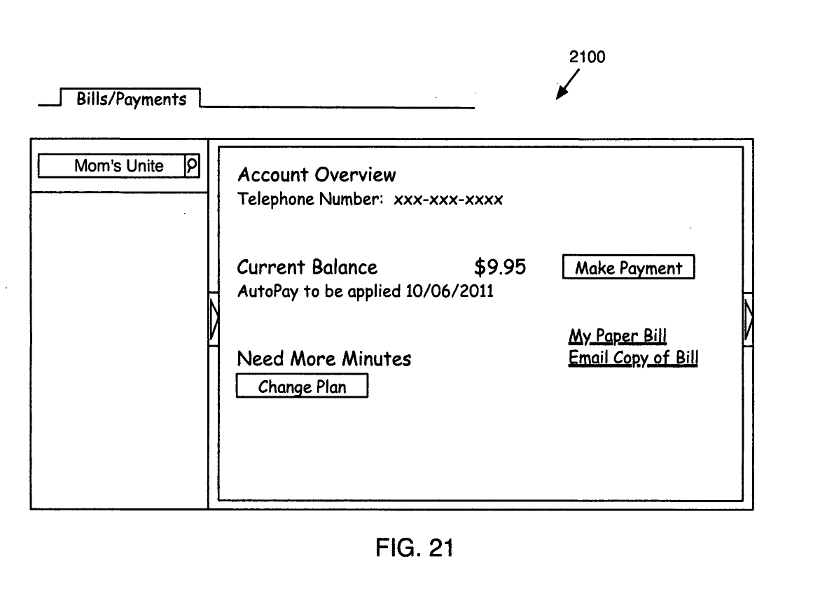

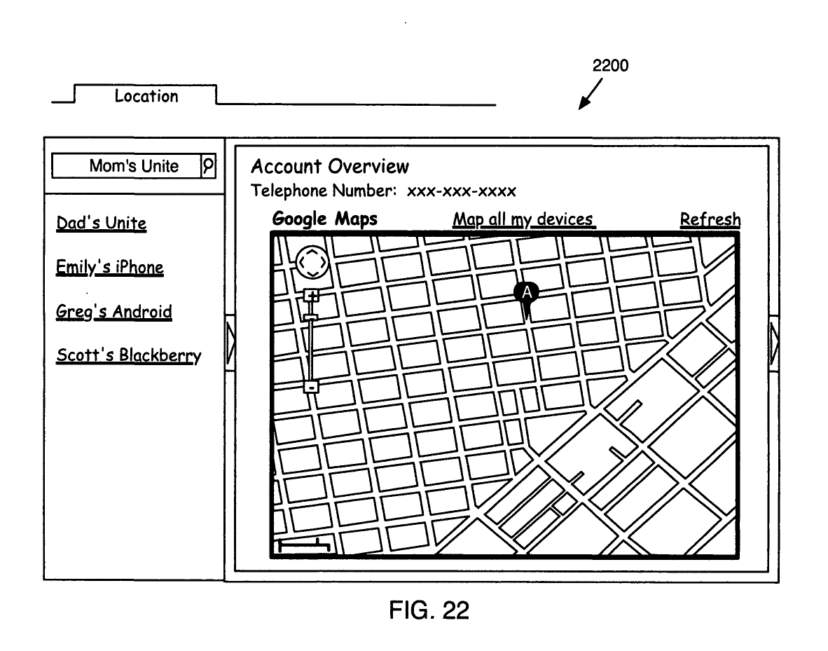

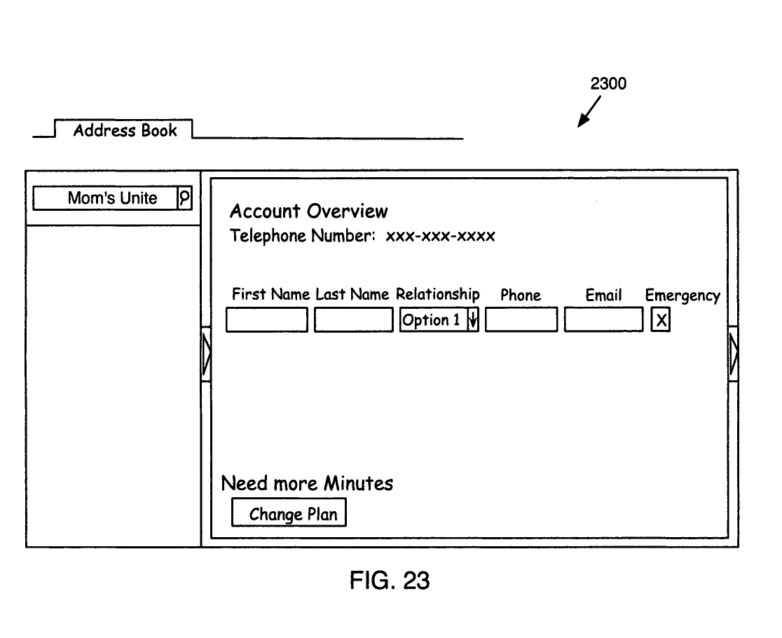

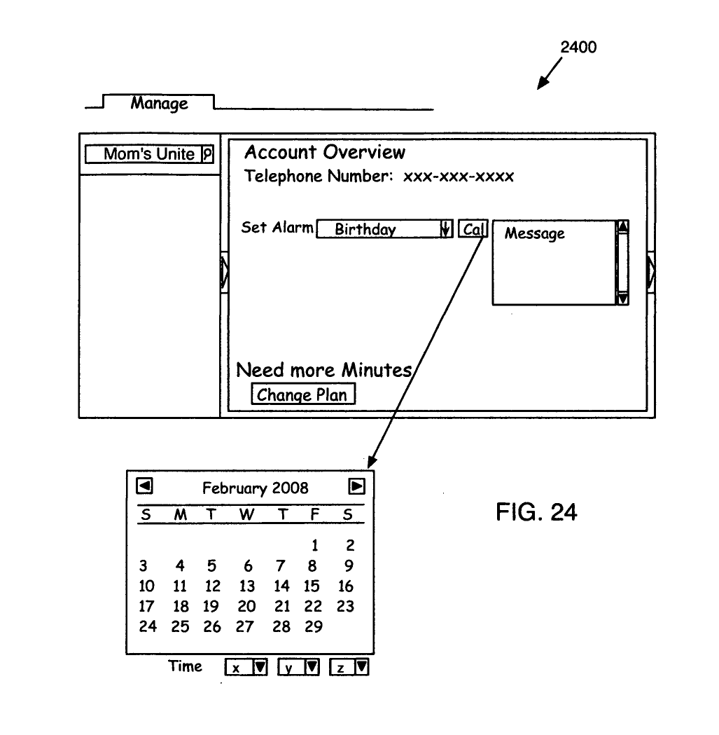

Turning now to FIGS. 20-24, illustrations of exemplary user interface screens are shown, e.g., as may be administered by system 1900 via portal 1930, including an interface for a home screen 2000 shown in FIG. 20 for reviewing and navigating mobile safety system account information. FIG. 21 shows an account overview and billing screen 2100 for providing detailed billing and transaction information. FIG. 22 illustrates a location screen that may be used to determining location of a mobile safety device using an administration system according to one embodiment of the invention, e.g., using GPS data from device 200 and location map information from Google Maps or another location mapping provider. FIG. 23 is a schematic illustration of a user interface address book or directory configuration screen 2300 that may be used to configure the contact directories and other information in a device 200 according to one embodiment of the invention. FIG. 24 is a schematic illustration of a user interface reminder configuration screen for a mobile safety device administration system according to one embodiment of the invention, whereby an administrator may set calendar entries, medication reminders, appointments, and other reminders or alarms to be provided to device 200 and its subscriber.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. Based on the above disclosure, other arrangements, embodiments, implementations and equivalents will be evident to those skilled in the art and may be employed without departing from the spirit and scope of the invention

What is claimed is:

1. A personal safety device, comprising:
a microcontroller;
a radio module in communication with the microcontroller, said radio module for communicating via a wireless telecommunications network;
a GPS module in communication with the microcontroller and configured to receive location information via the wireless telecommunications network;
a display in electrical communication with the microcontroller;
a user input device in communication with the microcontroller, said user input device comprising an emergency button and a call button;
a memory comprising instructions for calling an emergency call center and sending the location information from the GPS module across the network to at least one contact stored in the memory in response to a user holding the emergency button.

2. The device of claim 1, wherein said memory further comprises a secured directory including a plurality of contacts and instructions for receiving calls and text messages only from said plurality of contacts.

3. The device of claim 2, wherein said memory further comprises instructions for a communicating with a remote administration module for configuring said directory and said instructions for receiving calls and text messages.

4. The device of claim 2, wherein said memory further comprises a reminder module configured to storing appointment and medication information and alerts received over the network from the remote administration module.

5. The device of claim 2, further comprising a microphone, a speaker and an accelerometer in electrical communication with said microcontroller, and wherein said memory further comprises instructions for transmitting the location information from the GPS and a text message to a contact in the secured directory in response to a signal generated from the accelerometer.

6. The device of claim 2, further comprising a microphone, a speaker and an accelerometer in electrical communication with said microcontroller, and wherein said memory further comprises instructions for initiating a telephone call to a contact in the secured directory in response to a signal generated from the accelerometer, and for activating the speaker and the microphone to facilitate a hands-free conversation through the device.

7. The device of claim 1, further comprising a battery charger adapted to charge a battery disposed within said device while the device is positioned on a charging pad.

8. The device of claim 2, wherein said memory is further adapted to store medical history information and comprises instructions for transmitting the medical history information to a recipient computer system in response to a signal received by the device.

9. The device of claim 8, wherein the signal comprises a text message received over the wireless network.

10. The device of claim 2, wherein said memory further comprises instructions for placing a call to at least one of the plurality of contacts in response to a text message received from the contact.

11. The device of claim 2, wherein said memory further comprises instructions for sending the location information to at least one of the plurality of contacts in response to a text message received from the contact.
